(19) United States
(12) Patent Application Publication
(10) Pub. No.: US 2003/0227451 A1
(43) Pub. Date: Dec. 11, 2003

(54) Portable storage device with a storage capacity display

(76) Inventor: Chi-Tung Chang, Taipei (TW)

Correspondence Address: Alcor Micro, Corp., P. O. Box No. 6-57, Chung-Ho, Taipei, 235, TW

(21) Appl. No.: 10/163,551

(22) Filed: Jun. 7, 2002

(51) Int. Cl. G09G 3/04

(52) U.S. Cl. 345/211

(57) ABSTRACT

A portable storage device with a storage capacity display includes at least one display and one display control circuit, wherein the display control circuit is used to read the memory storage of a built-in or external flash memory of the portable storage device and converts it into displayable information to display the storage information on the display; the present invention is a portable storage device capable of instantly displaying storage information.

### BACKGROUND OF THE INVENTION

1) Field of the Invention

The present invention relates to a type of portable storage device with a storage capacity display, more especially to a type of portable storage device capable of displaying the storage capacity information and being used in conjunction with a flash memory data storage device.

2) Description of the Prior Art

Accordingly, flash memory and a variety of flash memory cards such as CF (Compact Flash), SM (Smart Media), Memory Stick and MMC/SD (Multimedia Card/Secure Digital) elements have been extensively used in occasions where digital data need to be stored; for example, in the application of a digital camera where the numeric data of the image as captured by the digital camera must be recorded; and with respect to the above mentioned flash memory elements in the case of reading or writing the numeric data, their execution will rely on the use of certain portable storage devices such as a card reader.

However, the commonly known portable storage device, whether it is a built-in fixed-capacity flash memory element or an external replaceable-capacity module, when in actual use, the user must first take note of the total storage capacity of the flash memory element and its remaining free storable capacity and then proceed with the reading and writing of data. Generally, the user needs to first connect such portable storage device with an operating system of a computer, or to connect it with an operating system of other types of data read-write devices such as a PDA; after following certain operating procedures, then the user knows of the aforementioned flash memory elements about its total memory capacity specification and the free storable capacity, thereby causing inconvenience and confusion in usage; particularly for those users unfamiliar with operating a computer or operating systems the problems related to the data recognition and operating difficulties will inevitably result in the programming and operations of reading, writing and accessing data.

### SUMMARY OF THE INVENTION

The primary objective of the present invention is to provide a portable storage device with a storage capacity display comprising at least one display and one display control circuit enabling instant binding with a built-in or an external flash memory element of the portable storage device for reading and displaying the memory storage status of the flash memory.

Another objective of the present invention is to provide a portable storage device with a storage capacity display, wherein a power supply circuit leads in and converts the power from a computer or an interface circuit of a read/write device that is connected to the portable storage device to directly drive the display of the storage capacity information in the flash memory element without going through the tedious operation of a computer operating system or the operating system of a read/write device.

In order to achieve the abovementioned objectives, the present invention of a portable storage device with a storage capacity display comprises at least one display disposed in a proper position on the exterior perimeter of the portable storage device; furthermore, at least one display control circuit disposed in the interior of the portable storage device, such display control circuit is used to read the memory storage information of a memory that is built-in or built-in or external to a portable storage device and convert it into displayable information to be read on the display.

To enable a further understanding of the detail structure and the practical operation of the present invention, the brief description of the drawings below is followed by the detailed description of the preferred embodiment.

### BRIEF DESCRIPTION OF THE DRAWINGS

FIG. 1 is a pictorial, exterior and structural drawing of the first exemplary implementation of the present invention.

FIG. 2 is a block diagram of the circuit of the present invention.

FIG. 3 is the second exemplary implementation of the present invention.

FIG. 4 is the third exemplary implementation of the present invention.

FIG. 5-1 is a block diagram of another exemplary implementation of the power supply circuit of the present invention.

FIG. 5-2 is another exemplary implementation of the power supply circuit of the present invention.

### DETAILED DESCRIPTION OF THE PREFERRED EMBODIMENTS

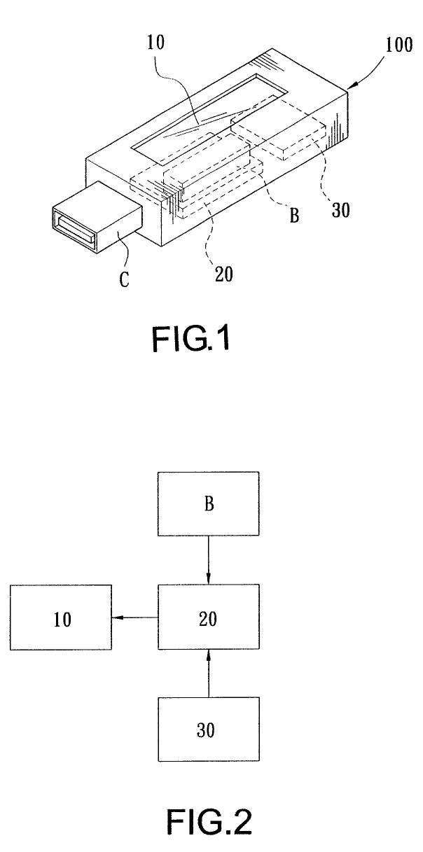

FIGS. 1 and 2 show the first exemplary implementation of the present invention of a portable storage device with a storage capacity display, wherein the type of portable storage device (100) may vary, and the first implementation example of the present invention uses a device that has a flash memory (B) disposed inside; furthermore, it has a connector (C) that connects with a computer or other types of read/write devices (not shown) such as a PDA. The portable storage device (100) comprises at least one display (10) of different types disposed in a proper position on the exterior perimeter of the portable storage device (100); the first exemplary implementation as indicated in FIG. 1 uses a liquid crystal display (LCD) for depiction.

At least one display control circuit (20), as shown in FIG. 2, is disposed in the interior of the portable storage device (100) to connect with the abovementioned flash memory (B) for reading the storage capacity information in the flash memory (B), including information about total memory storage capacity and usable free memory capacity and for converting the memory storage capacity data into a relative display data to be displayed through the presentation in the display (10) allowing the user to receive the memory storage information about the flash memory (B5) in a glance.

At least one power supply circuit (30), as shown in FIG, is disposed in the interior of the portable storage device (100); under the condition wherein the connector (C) is connected to a computer or other read/write devices, such power supply circuit (30) leads in and converts the power of an interface circuit of the connected computer or other read/write devices so as to provide the operating power for the above mentioned display (10) and display control circuit (20) to display the memory storage information of the flash memory (B).

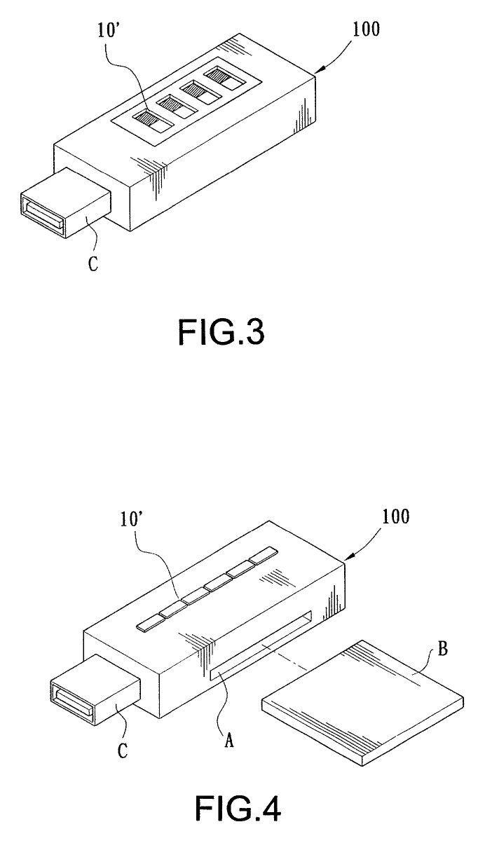

FIGS. 3 and 4 show the second and third exemplary implementations of the portable storage device (100) of the present invention, wherein, as the second exemplary implementation shown in FIG. 3, the display (10′) is a seven-level display type of LED that in operation can accomplish the same storage capacity display function as described in the abovementioned first exemplary implementation.

The third exemplary implementation, as shown in FIG. 4, is the portable storage device (100) using an external flash memory (B), wherein one side of the storage device (100) is disposed with an insert slot (A) for the insertion of the external flash memory (B) card, such as CF (Compact Flash) and SM (Smart Media) cards. The display (10) is of the staircase type of LED display and uses different number of lighted indicators to respectively depict the total memory capacity and the free storage capacity; in actual operation, it can accomplish the same storage capacity information display as that of the first and second exemplary implementations.

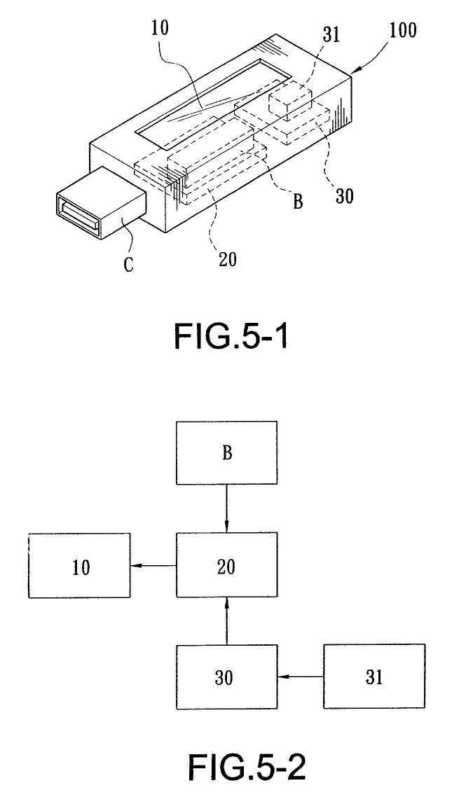

Furthermore, FIGS. 5-1 and 5-2 show another exemplary implementation and a block circuit diagram of the power supply circuit (30) of the present invention, wherein the power supply circuit (30) comprises at lease one independent power element (31) of unlimited types, such as a rechargeable battery or a direct current battery to allow the power supply circuit (30) to supply independent direct operating power currents to the display (10) and the display control circuit (20) so as to allow the display (10) and the display control circuit (20) to instantly display the storage capacity information of the flash memory (B) without having the connector (C) to be connected with a computer or other read/write devices.

In other words, without connecting to an operating system of a computer or other read/write devices, the memory storage capacity information of the flash memory (B) can be instantly and conveniently displayed by using the design of the independent power element (3).

The spirit of the present invention aims to use the easiest and simplest element structure to allow a portable storage device to directly display, through a display device, the memory storage capacity information of a built-in or external flash memory via a display, without connecting the portable storage device to an operating system of a computer or other types of read/write devices. This is an innovative structure in the field of portable storage devices that allows the user to obtain memory storage capacity information in a most simple and direct fashion.

The above illustrated the present invention of a portable storage device with a storage capacity display, wherein the revealed illustration, drawings and diagrams are means to clarify the technology content and the techniques used in the present invention. The revealed and preferred implementation examples are only an example and should not be used to limit the scope thereof. Furthermore, all modifications or changes to the structural details of the present invention, or the substitution or replacement of the elements with the equivalent effects, shall not depart from the spirit and scope of the present invention defined by the patent application as follows.

1. A portable storage device with a storage capacity display comprising:
at least one display disposed in a proper position on the exterior perimeter of the portable device;
at least one display control circuit disposed in the interior portion of the portable storage device to bind a flash memory connected with the portable storage device for reading the internal storage capacity information of the flash memory and converting the memory storage capacity information into displayable data to be displayed via the display.

2. The portable storage device with a storage capacity display according to claim 1, wherein the portable storage device is disposed with a power supply circuit for supplying the operating power required by the display and the display control circuit to execute the display of the storage capacity.

3. The portable storage device with a storage capacity display according to claim 2, wherein the power supply circuit binds and converts the power from the interface circuit of a computer or other types of read/write devices connecting to the portable storage device for supplying the operating power required to show the storage capacity information by the display and the display control circuit.

4. The portable storage device with a storage capacity display according to claim 2, wherein the power supply circuit is disposed with an independent power source to supply the required operating power to the display and the display control circuit for independently displaying the memory capacity.

5. The portable storage device with a storage capacity display according to claim 4, wherein the independent power element of the power supply circuit is a rechargeable or a direct current battery.

6. The portable storage device with a storage capacity display according to claim 1, wherein the display is a liquid crystal display (LCD).

7. The portable storage device with a storage capacity display according to claim 1, wherein the display is a seven level LED display.

8. A portable storage device with a storage capacity display according to claim 1, wherein the display is a staircase LED display.
